(19) United States
(12) Patent Application Publication
(10) Pub. No.: US 2003/0055620 A1
(43) Pub. Date: Mar. 20, 2003

(54) Method for self-validation of molecular modeling

(75) Inventors: Michael G. Hollars, Sunnyvale, CA (US); Michael A. Sherman, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Protein Mechanics, Mountain View, CA (US)

(21) Appl. No.: 10/052,919

(22) Filed: Nov. 2, 2001

Related U.S. Application Data
(60) Provisional application No. 60/245,734, filed on Nov. 2, 2000.
(60) Provisional application No. 60/245,730, filed on Nov. 2, 2000.
(60) Provisional application No. 60/245,731, filed on Nov. 2, 2000.
(60) Provisional application No. 60/245,688, filed on Nov. 2, 2000.

(51) Int. Cl. G06G 7/48; G06G 7/58

(52) U.S. Cl. 703/11; 703/12

(57) ABSTRACT

The present invention provides for a method for validating a computer modeling of a molecular system. The method has the steps of selecting a model parameter of the molecular system; selecting a validation measure of the molecular system; simulating the molecular system by the computer modeling with the selected model parameter; then determining a value of the validation measure of said molecular system from the simulating step; and testing whether the value of the validation measure is in a predetermined range to validate the computer modeling. The method can be performed iteratively by varying the model parameter continuously, such as varying a temperature model parameter, or discretely, such as substituting for different residues in a protein.

### CROSS-REFERENCES TO RELATED APPLICATIONS

This application is entitled to the benefit of the priority filing date of Provisional Patent Application No. 60/245,734, filed Nov. 2, 2000, and in addition, co-pending Provisional Patent Application No. 60/245,730, filed Nov. 2, 2000; No. 60/245,731, filed Nov. 2, 2000; and No. 60/245,688, filed Nov. 2, 2000; all of which are hereby incorporated by reference.

### BACKGROUND OF THE INVENTION

The present invention is related to the field of molecular modeling and, more particularly, to computer-implemented methods for the dynamic modeling and static analysis of large molecules.

The motion of bodies is determined by Newton's Laws of Motion. For a body subject to a force, Newton's Second Law states:

F=mα

or the acceleration α of the body is equal to the total force upon the body. This simple equation hides enormous complexity for the dynamic modeling and static analysis of large molecules. The acceleration of the body is the time derivative of velocity of the body and to determine the velocity of the body, its acceleration must be integrated with respect to time. Likewise, the velocity of a body is the time derivative of position of the body and to determine the position of the body, its velocity must be integrated with respect to time. Thus with knowledge of the force upon a body, integration operations must be performed to determine the velocity and position of the body at a given time.

In a molecule, there are multiple bodies whose motions must be considered. Each body, an atom, of the molecule is subject to multiple and complex forces. Thus the calculation of the motion and the shape of the molecule requires the determination of the position and motion of each atom of the molecule. Hence the calculation of the structure, dynamics and thermodynamics of molecules, including complex molecules having thousands of atoms, by computers would seem to be the perfect answer.

Indeed, the field of molecular modeling has successfully simulated the motion (molecular dynamics or MD) and the rest states (static analysis) of many complex molecular systems by computers. Typical molecular modeling applications have included enzyme-ligand docking, molecular diffusion, reaction pathways, phase transitions, and protein folding studies. Researchers in the biological sciences and the pharmaceutical, polymer, and chemical industries are beginning to use these techniques to understand the nature of chemical processes in complex molecules and to design new drugs and materials accordingly. Naturally, the acceptance of these tools is based on several factors, including the accuracy of the results in representing reality, the size of the molecular system that can be modeled, and the speed by which the solutions are obtained. The accuracy of the solutions is generally accepted.

However, the validity of the models should be tested and the models refined if any modeling approximations are inappropriate. In current practice, computed results are compared with empirical results measured in the laboratory. The present invention can exploit internal consistency requirements to obtain a degree of validation from the computational method directly, without recourse to the laboratory.

### SUMMARY OF THE INVENTION

The present invention provides for a method for validating a computer modeling of a molecular system. The method has the steps of selecting a model parameter of the molecular system; selecting a validation measure of the molecular system; simulating the molecular system by the computer modeling with the selected model parameter; then determining a value of the validation measure of said molecular system from the simulating step; and testing whether the value of the validation measure is in a predetermined range to validate the computer modeling. The method can be performed iteratively by varying the model parameter continuously, such as varying a temperature model parameter, or discretely, such as substituting for different residues in a protein.

### BRIEF DESCRIPTION OF THE DRAWINGS

FIG. 1 is a flow chart of self-validation method for a molecular model, according to the present invention;

FIG. 2 is a representation of an exemplary rigid multibody system model of an alanine dipeptide in accordance with the present invention;

FIG. 3A is a detail of the FIG. 1 model to illustrate the joint reactions exerted on the peptide bond of the alanine dipeptide;

FIG. 3B illustrates the addition of a pin joint to refine the peptide bond model of the alanine dipeptide in accordance with the present invention;

FIG. 3C illustrates the addition of a slider joint to refine the peptide bond model of the alanine dipeptide in accordance with the present invention;

FIG. 4 is a plot of the torque magnitude versus simulation time for a polypeptide rigid multibody system model;

FIG. 5 is a plot of the calculated minimum potential energy versus starting angle ψ of an alanine dipeptide rigid multibody model; and

FIG. 6 is a graph of the calculated minimum potential energy of a dipeptide alanine-R, where R are various discrete peptide residues interchanged.

### DESCRIPTION OF THE SPECIFIC EMBODIMENTS

The computer molecular modeling may be self-validated in accordance with the present invention. Molecule modeling and simulations are made with certain approximations, such as rigid body approximations of clusters of atoms, and the parameters of the models of the force fields, solvents, initial conditions, and other environmental and internal models. Though the present invention is not necessarily limited to such molecular modeling and simulations as described in co-pending U.S. patent application Ser. No. ______, entitled “METHOD FOR LARGE TIMESTEPS IN MOLECULAR MODELING” and claiming priority to the above-referenced Provisional Patent Application No. 60/245,688; U.S. patent application Ser. No. ______, entitled “Method for Residual Form in Moecular Modeling “and claiming priority to the above-referenced Provisional Patent Application No. 60/245,731; and U.S. patent application Ser. No. ______, entitled “ “and claiming priority to the above-referenced Provisional Patent Application No. 60/245,730; all of which patent applications filed of even date, assigned to the present assignee and incorporated by reference in their entirety, the resulting high-speed molecular modeling taught therein are particularly useful in exploiting the advantages of the present invention.

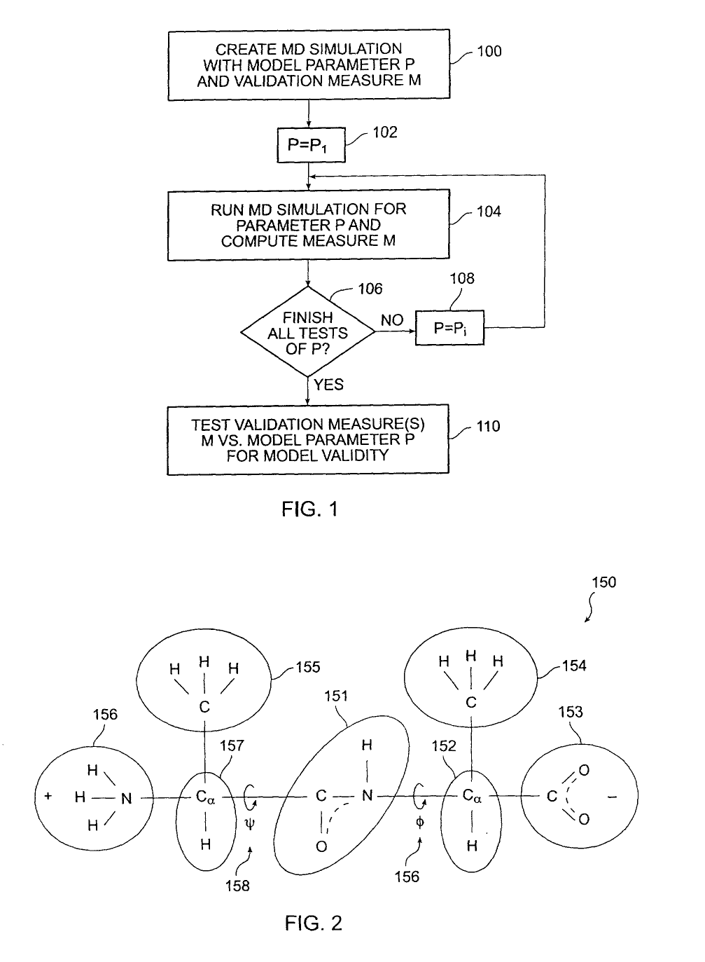

FIG. 1 illustrates a flow chart of the general steps of the molecular modeling self-validation method of the present invention. In initial step 100 a molecular dynamics (MD) simulation is created with a model parameter P and a validation measure M. Parameter P is chosen to test a particular modeling assumption or approximation, such as the rigid-body modeling assumption discussed in the above referenced co-pending applications, a constant of an atomic force field or solvent model, or even structure of the model itself (the particular amino acid sequence). Measure M is a result of the MD simulation and is chosen to validate the modeling assumption or approximation.

The modeling parameter P is set to its initial value in step 102. The MD simulation is run in step 104 for the current setting of P, and the measure M is computed. Step 106 tests whether all the settings of P have been run. If not, then P is set to a new value by step 108, and the simulation is re-run. If all settings of P have been tested, then the testing of the validation measures occurs in step 110. With this method, different types of parameters P can be tested. The particular parameter P determines how many settings of P are required for the validation method, how the measures M are derived to test P, and exactly how the validation tests are conducted.

Two general types of validation tests can be used. In the first type, the molecular model is run with one or more settings or substitutions of the modeling parameter P: P₁, P₂ . . . Pᵢ . . . Pₙ. Then the validity measure M is tested to determine whether it lies within a specified range:

Mₘᵢₙ<M<Mₘₐₓ

If M is outside the valid range, then the model should be modified, and the validation test rerun until M falls within the desired range.

In the second type of validation test, the simulation test is run with two settings of P, i.e., P₁ and P₂, with two resulting measures of M, M₁ and M₂. Then the partial derivative of M with respect to P is tested to determine the partial derivative lies within a specified range:

$$\frac{\partial M}{\partial P} \approx \frac{Δ M}{Δ P} = \frac{{M}_{2} - {M}_{1}}{{P}_{2} - {P}_{1}}$$

$${( \frac{\partial M}{\partial P} )}_{min} < \frac{\partial M}{\partial P} < {( \frac{\partial M}{\partial P} )}_{max}$$

If

$$\frac{\partial M}{\partial P}$$

is outside the valid range, then the model should be modified, and the validation test is rerun until

$$\frac{\partial M}{\partial P}$$

falls within the desired range.

Note that for first validation test, the parameter P can vary discretely, as well as continuously. However, for second validation test, the parameter P can only vary continuously because of the need to take a derivative with respect to P. Examples of continuously variable parameters for molecular modeling include temperature, pressure, and variables in a particular force field or solvent model. Examples of discretely variable parameters in a model include which atoms of the molecule are best modeled as rigid body subunits, which complete solvent or force field model should be used for the molecular model system, and the presence/absence of other molecules, such as chaperons in the case of protein folding simulations.

Examples of measures M that may be used to test the validity of the molecular model include the potential energy of the molecule, the reaction forces and moments on the rigid bodies used to model collections of atoms, and the RMS (root mean square) deviation error in the static structures of a folded protein.

As stated previously, the present invention can be used to full advantage with modeling and simulation techniques which have a significant speed-up in the calculation of results, such as disclosed in the above-referenced co-pending U.S. applications. This should be evident from the description of the exemplary self-validation tests below.

Examples of Self-Validation Tests

A molecular model useful in simulations is one with multiple rigid bodies for different groups of constituent atoms of the subject molecule. The previously referenced co-pending patent applications describe an Order (N) torsion angle, rigid multibody systems which can simulate complex molecules. One assumption in this particular model is that the covalent peptide bonds and covalent bonds to the residue side chains of the subject molecule do not stretch or bend to any sufficient amount that would invalidate the motion behavior or shape of the molecule. To validate that these bonds do not stretch significantly, the internal reaction forces and torques at the bond locations during the entire dynamic simulation or at static solutions can be computed. If any of these reactions exceed the level necessary to stretch bonds beyond an acceptably small amount, then the particular molecular modeling solution may be invalid.

Tests to Validate Rigid Body Models

FIG. 2 illustrates the structure of a protein fragment with two residues, alanine dipeptide 150, in a rigid body model as described above. Alanine dipeptide has the amino acid formula of Ala-Ala, and the chemical formula of

NH₃⁺—CH—C_{α}H—CH₃—CONH—C_{α}H—CH₃—COO⁻

where C_{α} are the alpha carbons in each residue and CONH is the rigid peptide body 154 between each residue. The multibody system description contains seven bodies 151-157 with several atoms per body. Each body consists of one or more atoms that are considered rigidly attached together. The seven bodies represent a total of 23 atoms and the connections between the rigid bodies are covalent bonds represented as pin joints that allow the bodies to rotate with respect to each other, but not to stretch or bend in other directions. Two of the pin joints on either side of the peptide body 151 are the configuration angles φ 156 and ψ 158.

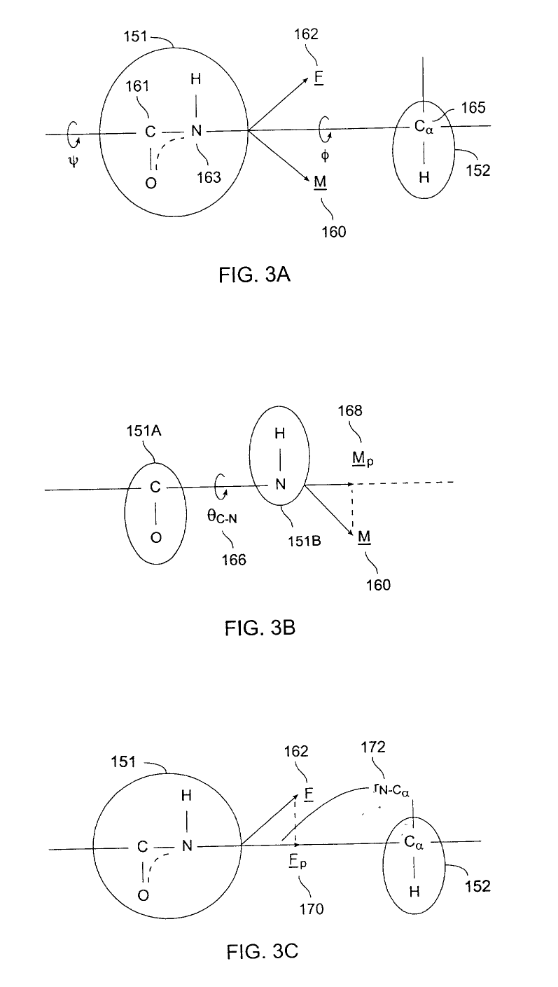

FIG. 3A illustrates a reaction moment M 160 and reaction force F 162 and acting at the pin joint for the angle φ of the peptide body 151. In reality, the peptide body 151 may twist at an angle θ_{C-N} between the carbon atom (C) 161 and the nitrogen atom (N) 163, or stretch by a displacement r_{N-C}_{_{α}} between the nitrogen atom (N) 163 and the alpha carbon (C_{α}) 165 if these reactions are too large. Self-validation test of the first type may be used since the collection of atoms assembled in each rigid body is discrete and not continuous.

FIG. 3B illustrates the method for refining the rigid body model if the reaction moment M exceeds the maximum allowed for the model. Here the discrete modeling parameter P is whether the peptide 151 should be considered as twisting into two rigid bodies or not, given the measure of the reaction moment M. In this test, the peptide body 151 is broken into two smaller bodies 151A and 151B with a new pin joint connecting the two bodies at an angle θ_{C-N} 166. The reaction moment M is projected onto the axis aligned with the pin joint for the angle θ_{C-N} and is the projected moment M_{P} 168. If the magnitude of the projected moment exceeds the magnitude of maximum allowable moment ∥M_{P}∥>∥Mₘₐₓ∥, then the pin joint for the angle θ_{C-N} 166 is added to the model along with the appropriate restoring moment, and the simulation is rerun.

FIG. 3C illustrates the method for refining the rigid body model if the reaction force F exceeds the maximum allowed for the model. In this example, the discrete modeling parameter is whether the peptide body 151 and a neighboring body 152 are displaced or not, given the measure M of the reaction force. For this test, a new slider joint connecting the two bodies 151 and 152 is created with the displacement r_{N-C}_{_{α}} 172. The reaction force F 162 is projected onto the axis aligned with the slider joint for the displacement r_{N-C}_{_{α}} and is the projected force F_{P} 170. If the magnitude of the projected force exceeds the magnitude of maximum allowable force ∥F_{P}∥>∥Fₘₐₓ∥, then the slider joint for the displacement r_{N-C}_{_{α}} is added to the model along with the appropriate restoring force, and the simulation is rerun.

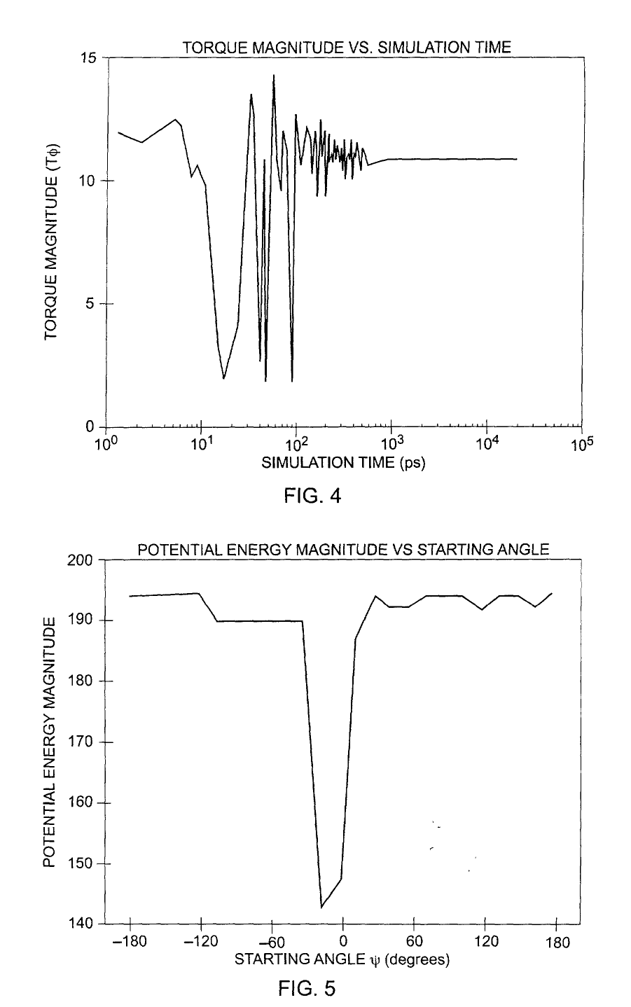

FIG. 4 is an exemplary graph of such a reaction force plotted for a simulation of alanine dipeptide with the model and integrators for the equations of the model's motions as described in the previously cited co-pending patent applications. If, after the molecular model settles at the final time, the reaction exceeds an allowable maximum time, then the model can be refined and rerun. This is another example of the present invention's self-validation method.

Tests to Validate Force Field and Solvent Models

The simulation of molecules and their behavior includes various approximations of the forces (including solvent forces) that actually move the molecules in nature. Extremely complex quantum mechanical formulations of inter-atomic forces are often approximated as simplified mathematical functions or truncated series expansions with parameters chosen by experimental observations. There are various force models available, such as “Amber,” “Charmm,” and “MM3” which are all different approximations of the same forces in nature. Since these forces cannot be known precisely, it is crucial to determine whether particular computational results are excessively dependent on unrealistic precision with respect to these models.

The parameters in these force models can be varied and rerun all or a portion of the molecular simulation to test internal consistency. A particular scalar function, or set of functions, which measures the deviation between two different solutions is specified, such as the RMS deviation between atom positions in two computed protein structures. When two solutions are provided by varying only a single parameter, the numerical value of this function gives the partial derivative, or the sensitivity of the solution with respect to that parameter. This so-called “sensitivity analysis” allows the determination of how robust or sensitive the folding path, final structure, and final potential energy is to changes in the force models or other parameters in the force models. In turn, this knowledge can be used to isolate particular parameters for refinement or to determine that a particular computation is unreliable.

These sensitivity analyses also apply to any other parameterized models used in the simulation of a molecule, such as the solvent model, temperature, and pH. With a measure function or set of measure functions, repeated runs of the simulation evaluate the sensitivity of the measure functions with respect to continuously changing individual modeling parameters. For example, sensitivity analyses can be applied to molecular dynamics and statics simulations of protein folding and ligand docking.

FIG. 5 illustrates such a continuous sensitivity analysis. The model is the alanine dipeptide protein fragment 150 of FIG. 2. The parameter varied is the initial value of the ψ angle 158 at the start of the simulation. The measure plotted is the magnitude of the final potential energy of the molecule after a static analysis is run to find a resting potential energy state. In this sensitivity analysis, the parameter is varied from −180° to +180°. In this self-validation test, a particular force field and solvent model are tested to verify that the final potential energy of the molecule should stay the same regardless of the initial starting position of the atoms of the molecule. Since the initial starting angle can vary continuously, both the first and second types of self-validation tests can be performed. Note that the magnitude of the potential energy stays approximately the same, except near the value of ψ=0. Thus a first type of validation test shows that the model breaks down by plotting the measure of the potential energy, E, for all starting values of ψ. A second type of validation test shows that the change of E with respect to ψ near ψ=0 is too large, i.e.,

$$\frac{\partial E}{\partial ψ} > {( \frac{\partial E}{\partial ψ} )}_{max} .$$

The information gleaned from this plot is used to refine the force field and solvent model.

Test to Validate Structural Insensitivity

The present invention can also be used to test the molecular model for the structural insensitivity. For example, a folded protein structure or its response to a ligand docking is often insensitive to the actual sequence of residues in certain regions of the amino acid sequence. Thus, slight genetic variations in the amino acid sequence do not change the form or function of the protein. In accordance with the present invention, the simulation of the motions of the molecular model allows the variation of the residues to determine the sensitivity of the folding path, final structure, ligand docking, and potential energy to changes in residue sequence. In this embodiment of the present invention, the parameter being changed is discrete, such as the amino acid sequence rather than a continuous force field or other modeling parameter.

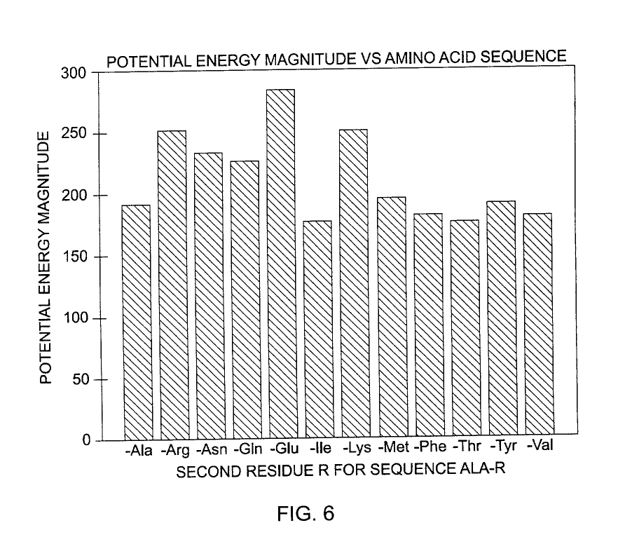

FIG. 6 illustrates such a discrete sensitivity analysis. The model is related to the alanine dipeptide protein fragment 150 of FIG. 2. The parameter varied is the second residue in the dipeptide. That is, the second alanine is replaced with an Arginine, then an Aspartine, etc. The measure plotted is the final potential energy of the molecule after a static analysis is run to find a minimum potential energy state. In this sensitivity analysis, the parameter is discretely varied from one amino acid residue to another amino acid residue. In this exemplary self-validation case, the magnitude of the final potential energy E for each case is within the tolerance for the model used: Eₘᵢₙ<E<Eₘₐₓ.

Conclusion

Of course, one way of testing a molecular model is to compare the simulation solutions to known native protein structures or drug ligand binding (as experimentally determined by X-ray crystallography or NMR (nuclear magnetic resonance) techniques). The present invention also allows for the validation of protein structures and ligand bindings determined by simulation, but not yet experimentally analyzed. The present invention exploits features of high-speed simulation methods to test the validity of certain approximations employed in the modeling process, namely the rigid body assumption, the force and solvent models, and of proteins with the particular amino acid sequence specified. In accordance with other aspects of the present invention, the sensitivity of molecular models to changes in a particular amino acid sequence can be applied to the field of protein design. For example, by modeling proteins with insensitivities to certain parameters, such as temperature or pH, actual proteins can be modified for stability in certain applications, such as detergent enzymes.

As a further example of self-validation, the present methods allow one to assess the significance of estimates of partial charge present on atoms of a molecular system. For example, the partial charge on an atom might be estimated as 0.5 electron units +/−0.1. The molecular system is simulated based on this selected parameter, and a value of a validation measure, such as a binding affinity, is determined from the resulting model. The simulation is then repeated using a different value for the charge on the atom within the margin of error (e.g., 0.6 electron units) and a second value of the validation measure is determined. If the validation measure does not change significantly, then one has an indication that the model is reliable, as is the binding affinity calculated. If, however, the binding affinity changes significantly (e.g., by a factor of 2), then one knows that the binding affinity determined may be significantly in error, and that the model needs refinement.

As a further example, the model parameter can be the identity of an atom or group of atoms within a molecule of the molecular system. For, example, the model parameter can be the identity of an amino acid. The molecular system can be simulated for different amino acids. If the model is accurate, one would expect that conservative changes between amino acids (see e.g., Stryer, Biochemistry (Freeman, N.Y., 4th Ed 1995), would result in relatively minor changes of a validation measure, and that nonconservative changes would result in larger changes. In such measures, the validation measure can be a quantitative value, such as the binding affinity of the protein for a target, or a qualitative result such as the shape of the folded protein. Although testing of a single position is not necessarily conclusive, in general, if conservative substitutions give rise to smaller changes than nonconservative substitutions in the validation measure, then one has reason to think the computer modeling of the molecular simulation is accurate.

As a further example, the model parameter can be the temperature of the molecular system. The molecular system can be simulated for different temperatures, and validations measurements made at the different temperatures. In this case, a suitable validation measure is the velocity of atoms in the molecular system. If the model is accurate, the velocity of atoms should increase, as does the temperature. Similarly, if the model parameter is pressure, the velocity of atoms should also increase with increasing pressure.

If a model survives the test of self-validation, then validation measures of the model can also be compared with experimentally determined measures of the same system as a further check. However, by first performing a self-validation, the need for chemical synthesis and chemical or biochemical assays to perform validation is at least reduced.

The validated molecular modeling system can then be used in various applications including screening libraries of compounds for interaction with a target, as discussed in Background section. Compounds that appear to have the desired interaction with the target identified by molecular modeling can then be synthesized chemically and tested in biochemical assays.

Therefore, while the foregoing is a complete description of the embodiments of the invention, it should be evident that various modifications, alternatives and equivalents may be made and used. Accordingly, the above description should not be taken as limiting the scope of the invention which is defined by the metes and bounds of the appended claims.

What is claimed is:

1. A method for validating a computer modeling of a molecular system, said method comprising
selecting a model parameter of said molecular system;
selecting a validation measure of said molecular system;
simulating said molecular system by said computer modeling with said selected model parameter;
then determining a value of said validation measure of said molecular system from said simulating step; and
testing whether said value of said validation measure is in a predetermined range to validate said computer modeling.

2. The method of claim 1, wherein the model parameter is rigidity of a bond formed between two atoms in the molecular system.

3. The method of claim 1, wherein the model parameter is a bond length or bond angle between two atoms in the molecular system.

4. The method of claim 1, wherein the model parameter is temperature or pressure of the molecular system.

5. The method of claim 1, wherein the model parameter is the identity of an atom or group of atoms in the molecular system.

6. The method of claim 1, wherein the model parameter is the charge on an atom in the molecular system.

7. The method of claim 1, wherein the validation measure is selected from the group consisting of a force between atoms in the molecular system, a bond length or angle between atoms of the molecular system, shape of the molecular system, binding affinity between components of the molecular system, and velocity of atoms of the molecular system.

8. The method of claim 1, wherein the model parameter is rigidity of a bond between atoms in the molecular system, the validation measure is a force acting on the atoms, and the predetermined range is a range of forces compatible with a rigid bond between the atoms.

9. The method of claim 1, further comprising synthesizing a compound component of the molecular system, determining a value of the validation measurement for the synthesized compound, and comparing the value for the synthesize compound to value of the validation measure for the molecular system.

10. The method of claim 1, further comprising
varying said model parameter of said molecular system;
simulating said molecular system by said computer modeling with said varied model parameter;
then redetermining said value of said validation measure of said molecular system from said simulating step; and
retesting whether said redetermined value of said validation measure is in a predetermined range to validate said computer modeling.

11. The method of claim 10, wherein model parameter is charge of an atom of the molecular system, the validation measure is a binding affinity between compound and target components of the molecular system, one of which contains the atom, the predetermined range is a range of binding affinities, and the varying step varies the magnitude of the charge on the atom.

12. The method of claim 10, wherein the model parameter is temperature, the validation measure is velocity of atoms of the molecular system, the predetermined range is a range of velocities, and the varying step varies the temperature of the model system.

13. The method of claim 10, wherein the model parameter is identity of an amino acid in a protein component of the molecular system, the validation measure is a binding affinity of the protein component for a target component of the molecular system, the predetermined range is a range of binding affinities, and the varying step varies the identity of the amino acid.

14. The method of claim 13, wherein the varying step varies the identity of the amino acid by a conservative substitution.

15. The method of claim 13, wherein the varying step varies the identity of the amino acid by a nonconservative substitution.

16. The method of claim 10, wherein said varying, simulating, redetermining and retesting steps are performed iteratively.

17. The method of claim 10, wherein in said varying step said model parameter is varied discretely.

18. The method of claim 10, wherein in said varying step said model parameter is varied continuously.

19. A method for validating a computer modeling of a molecular system, said method comprising
selecting a model parameter of said molecular system;
selecting a validation measure of said molecular system;
simulating said molecular system by said computer modeling with said selected model parameter;
then determining a value of said validation measure of said molecular system from said simulating step;
varying said model parameter of said molecular system;
resimulating said molecular system by said computer modeling with said varied model parameter;
then redetermining a value of said validation measure of said molecular system from said simulating step; and
calculating a derivative from a change in said validation measure with respect to a change in said model parameter;
testing whether said derivative is in a predetermined range to validate said computer modeling.

20. A method for validating a computer modeling of a molecular system, said method comprising
selecting a model parameter of said molecular system;
selecting a validation measure of said molecular system;
simulating said molecular system by said computer modeling with said selected model parameter;
then determining a first result of said validation measure of said molecular system from said simulating step; and
varying the model parameter of the molecular system
simulating said molecular system by said computer modeling with said varied model parameter;
determining a second result of said validation measure of said molecular system from said simulating step;
determining whether the difference between the first and second results is expected from the variation in the validation measure.
